(19) United States
(12) Patent Application Publication
(10) Pub. No.: US 2001/0014703 A1
(43) Pub. Date: Aug. 16, 2001

(54) PROCESS FOR RIGID POLYURETHANE FOAMS

(76) Inventors: RIK DE VOS, VARESE (IT); WALTER BAZZO, VARESE (IT); GUY LEON JEAN GHISLAIN BIESMANS, EVERBERG (BE); LUC FERDINAND LEON COLMAN, BELSELE (BE)

Correspondence Address: PILLSBURY MADISON & SUTRO, LLP, INTELLECTUAL PROPERTY, 1100 NEW YORK AVENUE, N.W., NINTH FLOOR - EAST TOWER, WASHINGTON, DC, 20005-3918, US

(21) Appl. No.: 09/253,956

(22) Filed: Feb. 22, 1999

(30) Foreign Application Priority Data
Feb. 25, 1998 (EP) 98103259.2

(51) Int. Cl. C08J 9/14; C08J 9/00

(52) U.S. Cl. 521/131; 252/182.24; 521/155; 521/902

(57) ABSTRACT

Process for preparing rigid polyurethane or urethane-modified polyisocyanurate foams comprising the step of reacting an organic polyisocyanate with a polyfunctional isocyanate-reactive component in the presence of a blowing agent mixture comprising from 50 to 90% by weight of cyclopentane and from 10 to 50% by weight of a mixture comprising isopentane and/or n-pentane and isobutane and/or n-butane wherein the weight ratio of isopentane and/or n-pentane over isobutane and/or n-butane is between 5/95 and 95/5.

This invention relates to processes for the preparation of rigid polyurethane or urethane-modified polyisocyanurate foams, to foams prepared thereby, and to novel compositions useful in the process.

Rigid polyurethane and urethane-modified polyisocyanurate foams are in general prepared by reacting the appropriate polyisocyanate and isocyanate-reactive compound (usually a polyol) in the presence of a blowing agent. One use of such foams is as a thermal insulation medium as for example in the construction of refrigerated storage devices. The thermal insulating properties of rigid foams are dependent upon a number of factors including, for closed cell rigid foams, the cell size and the thermal conductivity of the contents of the cells.

A class of materials which has been widely used as blowing agent in the production of polyurethane and urethane-modified polyisocyanurate foams are the fully halogenated chlorofluorocarbons, and in particular trichlorofluoromethane (CFC-11) . The exceptionally low thermal conductivity of these blowing agents, and in particular of CFC-11, has enabled the preparation of rigid foams having very effective insulation properties. Recent concern over the potential of chlorofluorocarbons to cause depletion of ozone in the atmosphere has led to an urgent need to develop reaction systems in which chlorofluorocarbon blowing agents are replaced by alternative materials which are environmentally acceptable and which also produce foams having the necessary properties for the many applications in which they are used.

Such alternative blowing agents proposed in the prior art include hydrochlorofluorocarbons, hydrofluorocarbons and especially hydrocarbons namely alkanes and cycloalkanes such as isobutane, n-pentane, isopentane, cyclopentane and mixtures thereof.

Preferred are mixtures of cyclopentane and isobutane as described, for example, in EP 421269, and mixtures of cyclopentane and isopentane or n-pentane, as described, for example, in WO 94/25514.

It is an object of the present invention to provide a hydrocarbon blowing agent mixture yielding improved foam properties and at the same time allowing easy processing.

These objects are met by using in the process of making rigid polyurethane or urethane-modified polyisocyanurate foams from polyisocyanates and isocyanate-reactive components a blowing agent mixture comprising from 50 to 90% by weight of cyclopentane and from 10 to 50% by weight of a mixture of isopentane and/or n-pentane and isobutane and/or n-butane wherein the weight ratio of isopentane and/or n-pentane and isobutane and/or n-butane is between 5/95 and 95/5.

Using such a blowing agent mixture allows easier processing than a mixture of cyclopentane and isobutane together with improved thermal insulation properties.

Compared to the use of a mixture of cyclopentane and iso- or n-pentane improved dimensional stability of the foams is obtained allowing for lower density stable foams.

Preferably the amount of cyclopentane in the blowing agent mixture is between 60 and 90 wt %, more preferably between 60 and 80 wt %, most preferably between 70 and 75 wt %, with the weight ratio iso- and/or n-pentane and isobutane and/or n-butane preferably being between 90/10 and 20/80, more preferably between 75/25 and 25/75, most preferably between 2/1 and 1/2.

The use in the present blowing agent mixture of isopentane is preferred over n-pentane as is the use of isobutane over n-butane.

As examples of preferred blowing agent mixtures for use in the present invention the following can be given: a mixture containing 70 wt % cyclopentane, 20 wt % isopentane and 10 wt % isobutane; a mixture containing 70 wt % cyclopentane, 10 wt % isopentane and 20 wt % isobutane; a mixture containing 75 wt % cyclopentane, 15 wt % isopentane and 10 wt % isobutane.

Suitable isocyanate-reactive compounds to be used in the process of the present invention include any of those known in the art for the preparation of rigid polyurethane or urethane-modified polyisocyanurate foams. Of particular importance for the preparation of rigid foams are polyols and polyol mixtures having average hydroxyl numbers of from 300 to 1000, especially from 300 to 700 mg KOH/g, and hydroxyl functionalities of from 2 to 8, especially from 3 to 8. Suitable polyols have been fully described in the prior art and include reaction products of alkylene oxides, for example ethylene oxide and/or propylene oxide, with initiators containing from 2 to 8 active hydrogen atoms per molecule. Suitable initiators include: polyols, for example glycerol, trimethylolpropane, triethanolamine, pentaerythritol, sorbitol and sucrose; polyamines, for example ethylene diamine, tolylene diamine (TDA), diaminodiphenylmethane (DADPM) and polymethylene polyphenylene polyamines; and aminoalcohols, for example ethanolamine and diethanolamlne; and mixtures of such initiators. Other suitable polymeric polyols include polyesters obtained by the condensation of appropriate proportions of glycols and higher functionality polyols with dicarboxylic or polycarboxylic acids. Still further suitable polymeric polyols include hydroxyl terminated polythioethers, polyamides, polyesteramides, polycarbonates, polyacetals, polyolefins and polysiloxanes. Especially preferred isocyanate-reactive compounds to be used in hydrocarbon blown systems are amine-initiated polyether polyols, especially aromatic amine initiated polyols such as TDA- and DADPM-initiated polyether polyols, as is described in WO 97/48748, the contents of which are incorporated herein.

Suitable organic polyisocyanates for use in the process of the present invention include any of those known in the art for the preparation of rigid polyurethane or urethane-modified polyisocyanurate foams, and in particular the aromatic polyisocyanates such as diphenylmethane diisocyanate in the form of its 2,4′-, 2,2′- and 4,4′-isomers and mixtures thereof, the mixtures of diphenylmethane diisocyanates (MDI) and oligomers thereof known in the art as “crude” or polymeric MDI (polymethylene polyphenylene polyisocyanates) having an isocyanate functionality of greater than 2, toluene diisocyanate in the form of its 2,4- and 2,6-isomers and mixtures thereof, 1,5-naphthalene diisocyanate and 1,4-diisocyanatobenzene. Other organic polyisocyanates which may be mentioned include the aliphatic diisocyanates such as isophorone diisocyanate, 1,6-diisocyanatohexane and 4,4′-diisocyanatodicyclohexylmethane.

The quantities of the polyisocyanate compositions and the polyfunctional isocyanate-reactive compositions to be reacted will depend upon the nature of the rigid polyurethane or urethane-modified polyisocyanurate foam to be produced and will be readily determined by those skilled in the art.

Other physical blowing agents known for the production of rigid polyurethane foam can be used together with the hydrocarbon blowing agent mixture of the present invention. Examples of these include other hydrocarbons, dialkyl ethers, cycloalkylene ethers and ketones, fluorinated ethers, chlorofluorocarbons, perfluorinated hydrocarbons, and in particular hydrochlorofluorocarbons and hydrofluorocarbons. Examples of suitable hydrochlorofluorocarbons include 1-chloro-1,2-difluoroethane, 1-chloro-2,2-difluoroethane, 1-chloro-1,1-difluoroethane, 1,1-dichloro-1-fluoroethane and monochlorodifluoromethane. Examples of suitable hydrofluorocarbons include 1,1,1,2-tetrafluoroethane, 1,1,2,2-tetrafluoroethane, trifluoromethane, heptafluoropropane, 1,1,1-trifluoroethane, 1,1,2-trifluoroethane, 1,1,1,2,2-pentafluoropropane, 1,1,1,3-tetrafluoropropane, 1,1,1,3,3-pentafluoropropane and 1,1,1,3,3-pentafluoro-n-butane.

Generally water or other carbon dioxide-evolving compounds are used together with the physical blowing agents. Where water is used as chemical co-blowing agent typical amounts are in the range from 0.2 to 5%, preferably from 0.5 to 3% by weight based on the isocyanate-reactive compound.

The total quantity of blowing agent to be used in a reaction system for producing cellular polymeric materials will be readily determined by those skilled in the art, but will typically be from 2 to 25% by weight based on the total reaction system.

In addition to the polyisocyanate and polyfunctional isocyanate-reactive compositions and the blowing agent mixture, the foam-forming reaction mixture will commonly contain one or more other auxiliaries or additives conventional to formulations for the production of rigid polyurethane and urethane-modified polyisocyanurate foams. Such optional additives include crosslinking agents, for example low molecular weight polyols such as triethanolamine, foam-stabilising agents or surfactants, for example siloxane-oxyalkylene copolymers, urethane catalysts, for example tin compounds such as stannous octoate or dibutyltin dilaurate or tertiary amines such as dimethylcyclohexylamine or triethylene diamine, isocyanurate catalysts, fire retardants, for example halogenated alkyl phosphates such as tris chloropropyl phosphate, and fillers such as carbon black.

In operating the process for making rigid foams according to the invention, the known one-shot, prepolymer or semi-prepolymer techniques may be used together with conventional mixing methods and the rigid foam may be produced in the form of slabstock, mouldings, cavity fillings, sprayed foam, frothed foam or laminates with other materials such as hardboard, plasterboard, plastics, paper or metal.

It is convenient in many applications to provide the components for polyurethane production in pre-blended formulations based on each of the primary polyisocyanate and isocyanate-reactive components. In particular, many reaction systems employ a polyisocyanate-reactive composition which contains the major additives such as the blowing agent in addition to the polyisocyanate-reactive component or components.

Therefore the present invention also provides a polyisocyanate-reactive composition comprising the present blowing agent mixture.

The present invention is illustrated, but not limited by the following examples.

### EXAMPLES 1-5

Refrigeration cabinets were filled with a polyurethane formulation containing the ingredients listed in Table 1 below.

Polyol is a polyol composition of OH value 390 mg KOH/g; Isocyanate is a polymeric MDI composition.

The reaction profile was followed in respect of cream time (time taken for the reaction mixture to start foaming) and string time (time taken for the reaction mixture to reach the transition point from fluid to cross-linked mass).

Free Rise Density of the foam was measured according to standard ISO 845.

Flow Index was determined as follows: the height a reference foam formulation of certain weight flows within a specified tube is set at 1.00; the height the sample foam formulation of the same weight flows within the same tube is then determined vis-a-vis this reference foam formulation. The cyclopentane blown foam (Example 1) is used as reference foam.

Lambda at 10° C. was measured according to standard ASTM C518.

The froth level of the foam was determined visually.

The fill weight represents the weight difference between the fridge cabinet filled with foam and the unfilled cabinet and was determined for Model 1 which is a single monovolume fridge with thick walls and a simple flow pattern and for Model 2 which is a combi-type fridge with a complex flow pattern.

Reverse Heat Leakage determines the energy loss (heat transfer) through a refrigeration cabinet when a steady state rate (of energy loss) is reached.

It is measured as follows: power is given to a closed and conditioned refrigeration cabinet; a heat flow is established from the internal and external surface; having established a steady state (thermal equilibrium) the power is measured; the RHL value is the power (in Watts) needed to maintain a prefixed temperature difference between interior and exterior (in this case a temperature difference of 20° C. was used). In Table 1 the RHL for the sample foams is represented relative to the reference foam (Example 1) of which the RHL is set at 100. The RHL values were determined only for Model 1 fridges.

Results are presented in Table 1 below.

TABLE 1

| Example No. | | 1 | 2 | 3 | 4 | 5 |
|---|---|---|---|---|---|---|
| Polyol | pbw | 100 | 100 | 100 | 100 | 100 |
| water | pbw | 2.1 | 2.1 | 2.1 | 2.1 | 2.1 |
| cyclopentane | pbw | 15 | 10.5 | 10.5 | 10.5 | 10.5 |
| isopentane | pbw | | 4.5 | | 2.0 | 1.0 |
| isobutane | pbw | | | 3.5 | 1.5 | 2.5 |
| Isocyanate | pbw | 144 | 144 | 144 | 144 | 144 |
| Cream time | sec | 4 | 4 | | 3 | |
| String time | sec | 38 | 37 | 38 | 37 | 38 |
| Free Rise | kg/m³ | 23.2 | 22.5 | 22.7 | 22.9 | 22.7 |
| Density | | | | | | |
| Flow Index | | 1.00 | 1.15 | 1.06 | 1.12 | 1.08 |
| Lambda | mW/mK | 20.0 | 20.3 | 20.8 | 20.3 | 20.5 |
| Froth Level | | none | none | heavy | none | gentle |
| Fill Weight | | | | | | |
| Model 1 | g | 3300 | 3000 | 2900 | 3000 | 3000 |
| Model 2 | g | 6600 | 6000 | 6000 | 5800 | 5900 |
| Reverse Heat | % | 100 | 101 | 104 | 101 | 103 |
| Leakage | | | | | | |

These results show that using a blowing agent mixture according to the invention (Examples 4 and 5) leads to foams of lower density than those blown with cyclopentane only (Example 1); also the flow of the foam formulation has improved leading to lower fill weights of the fridge.

Compared to foams blown with cyclopentane/isopentane mixtures (Example 2) lower fill weights are also obtained.

Compared to foams blown with cyclopentane/isobutane mixtures (Example 3) better flow (lower fill weights, especially for complex model fridges) and insulation properties (lambda and energy consumption) are obtained.

1. Process for preparing rigid polyurethane or urethane-modified polyisocyanurate foams comprising the step of reacting an organic polyisocyanate with a polyfunctional isocyanate-reactive component in the presence of a blowing agent mixture comprising from 50 to 90% by weight of cyclopentane and from 10 to 50% by weight of a mixture of isopentane and/or n-pentane and isobutane and/or n-butane wherein the weight ratio of isopentane and/or n-pentane over isobutane and/or n-butane is between 5/95 and 95/5.

2. Process according to claim 1 wherein the amount of cyclopentane in the blowing agent mixture is between 60 and 80% by weight and the amount of mixture of isopentane and/or n-pentane and isobutane and/or n-butane is between 20 and 40% by weight.

3. Process according to claim 1 or 2 wherein the weight ratio iso- and/or n-pentane over iso- and/or n-butane is between 75/25 and 25/75.

4. Process according to claim 3 wherein the weight ratio iso- and/or n-pentane over iso- and/or n-butane is between 2/1 and 1/2.

5. Process according to any one of the preceding claims wherein the blowing agent mixture comprises cyclopentane, isopentane and isobutane.

6. Process according to claim 5 wherein said blowing agent mixture is selected from the group consisting of a mixture of 70 wt % cyclopentane, 20 wt % isopentane, 10 wt % isobutane; a mixture of 70 wt % cyclopentane, 10 wt % isopentane, 20 wt % isobutane; a mixture of 75 wt % cyclopentane, 15 wt % isopentane, 10 wt % isobutane.

7. Rigid polyurethane or urethane-modified polyisocyanurate foam obtainable by the process as defined in any one of the preceding claims.

8. Isocyanate-reactive composition comprising a blowing agent mixture as defined in any one of claims 1 to 6.
